(19) United States
(12) Patent Application Publication
(10) Pub. No.: US 2015/0051320 A1
(43) Pub. Date: Feb. 19, 2015

(54) BOARD USING CROSSLINKED POLYLACTIC ACID AND METHOD FOR PREPARING SAME

(71) Applicant: LG Hausys, Ltd., Seoul (KR)

(72) Inventors: Cheng Zhe Huang, Cheongju-si (KR); Chang Won Kang, Cheongju-si (KR); Ji Hyang Son, Daejeon (KR)

(73) Assignee: LG Hausys, Ltd., Seoul (KR)

(21) Appl. No.: 14/385,615

(22) PCT Filed: Dec. 14, 2012
(86) PCT No.: PCT/KR2012/010913

§ 371 Date: Sep. 16, 2014

(30) Foreign Application Priority Data
Mar. 29, 2012 (KR) 10-2012-0032395

(51) Int. Cl. B29C 51/00; B27N 3/04; C08J 5/04

(52) U.S. Cl. CPC B29C 51/004; C08J 5/045; B27N 3/04; C08J 2367/04; C08J 2397/02; B29K 2067/046
USPC 524/14; 264/322; 264/485

(57) ABSTRACT

The present invention relates to a board using crosslinked polylactic acid and a method for preparing same, and more specifically, to a board using the crosslinked polylactic acid which has superior processing properties during the preparation process and superior water-resistant properties after processing, by using a composition comprising the crosslinked polylactic acid and wood fiber, and to a method for preparing the same.

### TECHNICAL FIELD

The present invention relates to a board using cross-linked polylactic acid and a method for preparing the same. More particularly, the present invention relates to a board, which includes cross-linked polylactic acid and wood fiber to exhibit excellent processability in a preparation process and excellent water resistance after processing, and a method for preparing the same.

### BACKGROUND ART

Boards using petroleum resins such as polyvinyl chloride (PVC) and the like are widely used to various building structures such as houses, mansions, apartments, offices, shops, and the like.

Such boards are prepared through extrusion or calendering of a resin such as polyvinyl chloride (PVC), and the like. However, since raw materials for these boards are obtained from limited resources such as crude oil, it is anticipated that the depletion of petroleum resources will lead to various problems related to the supply of raw materials.

Moreover, considering increasing interest in environmental problems in recent years, there is a problem in that polyvinyl chloride (PVC) boards are likely to emit toxic substances and create an environment burden when discarded.

Examples of existing boards include laminate flooring prepared using high density fiberboard (HDF), and the laminate flooring is a wood board prepared by coating an adhesive onto wood fibers obtained through defibration at high temperature, followed by molding and hot-pressing. Since the laminate flooring can be subjected to complicated machining and the like, the laminate flooring is widely used for interior finishing or overall furniture products.

However, although the adhesive is mainly composed of a urea-formaldehyde resin or a melamine-urea-formaldehyde resin, exhibits outstanding adhesion and is low-priced, the adhesive can irritate the eyes, nose and skin, as well as causing atopic diseases and bronchial asthma even after curing, and gradually emits formaldehyde, which can cause cancer when inhaled for a long time. In addition, excess melamine intake can result in formation of kidney stones in humans. Further, melamine, urea, formaldehyde and the like, which are prepared from fossil resources as raw materials, cause continuous price rise due to depletion of fossil resources, emit large amounts of greenhouse gases while consuming a large amount of energy in the preparation process, and emit a variety of toxic substances such as endocrine disruptors, toxic gases and the like, when incinerated.

To resolve such problems, a polylactic acid (or polylactide) resin, which is extracted and synthesized from plant resources, is spotlighted as a material capable of replacing petroleum resins in recent years. Polylactic acid is prepared by polymerization of lactic acid, which can be obtained by fermentation of starch extracted from renewable plant resources (corn, potatoes, sweet potatoes, and the like), and is an environmentally friendly resin enabling reduction in CO₂ emissions and conservation of non-renewable energy sources. A number of references including Korean Patent Publication No. 10-2008-0067424 disclose boards using a polylactic acid resin.

However, since polylactic acid is easily hydrolyzed at certain humidity and temperature, there is a drawback in that a board prepared from the polylactic acid resin clings to a processing apparatus upon thermal lamination or is not easily stacked in multiple layers due to lack of viscoelasticity upon high temperature processing, as compared with existing boards prepared from a PVC resin. Therefore, it is an important issue to improve water resistance and processability of the board prepared from the polylactic acid resin.

### DISCLOSURE

### Technical Problem

It is one aspect of the present invention to provide a board, which includes cross-linked polylactic acid and wood fiber to exhibit excellent processability in a preparation process and excellent water resistance after processing, and a method for preparing the same.

### Technical Solution

In accordance with one aspect of the present invention, a board includes a cross-linked polylactic acid resin and wood fiber, wherein the wood fiber is present in an amount of 50 parts by weight to 150 parts by weight based on 100 parts by weight of the cross-linked polylactic acid resin; and the cross-linked polylactic acid resin is obtained through heat-initiated crosslinking or irradiation.

In accordance with another aspect of the present invention, a method for preparing a board includes: preparing a polylactic acid resin mixture by mixing a polylactic acid resin, a crosslinking agent, and a crosslinking aid; crosslinking the polylactic acid resin mixture through heat-initiated crosslinking; preparing a composition for board formation, which includes the cross-linked polylactic acid resin and 50 parts by weight to 150 parts by weight of wood fiber based on 100 parts by weight of the cross-linked polylactic acid resin; and forming a board by thermoforming of the composition, followed by post-processing.

In accordance with a further aspect of the present invention, a method for preparing a board includes: preparing a polylactic acid resin mixture by mixing a polylactic acid resin and a crosslinking aid; crosslinking the polylactic acid resin mixture through electron beam irradiation crosslinking; preparing a composition for board formation, which includes the cross-linked polylactic acid resin and 50 parts by weight to 150 parts by weight of wood fiber based on 100 parts by weight of the cross-linked polylactic acid resin; and forming a board by thermoforming of the composition, followed by post-processing.

In accordance with yet another aspect of the present invention, a multilayer flooring material includes the board according to the invention.

In accordance with yet another aspect of the present invention, a method for preparing a multilayer flooring material includes the method for preparing a board according to the invention.

### Advantageous Effects

According to the present invention, since the board uses a polylactic acid resin modified through crosslinking, the board allows easy thermal processing due to increase in melt strength thereof and exhibits improved physical properties in terms of water resistance, tensile strength, elongation, and the like.

According to the present invention, since the board using the cross-linked polylactic acid resin is prepared using a plant resource-based polylactic acid resin instead of petroleum resource-based PVC generally used as a binder, the board can solve a problem of raw material supply due to depletion of petroleum resources.

According to the present invention, the board using the cross-linked polylactic acid resin emits a small amount of environmentally toxic substances such as HCl and the like in preparation thereof and is environmentally friendly by enabling easy disposal thereof.

### BEST MODE

The above and other aspects, features and advantages of the present invention will become apparent from the detailed description of the following embodiments in conjunction with the accompanying drawings. However, it should be understood that the present invention is not limited to the following embodiments and may be embodied in different ways, and that the embodiments are provided for complete disclosure and thorough understanding of the invention by those skilled in the art. The scope of the invention should be defined only by the accompanying claims and equivalents thereof. Like components will be denoted by like reference numerals throughout the specification.

Hereinafter, a composition for board formation using a polylactic acid resin, a board formed using the composition, and a method for preparing the board according to the present invention will be described in detail.

### Board

According to one embodiment of the invention, a board includes a cross-linked polylactic acid resin and wood fiber, wherein the wood fiber is present in an amount of 50 parts by weight to 150 parts by weight based on 100 parts by weight of the cross-linked polylactic acid resin; and the cross-linked polylactic acid resin is obtained through heat-initiated crosslinking or irradiation.

First, the cross-linked polylactic acid resin is a main component of the board according to the present invention and is prepared by crosslinking of a thermoplastic polyester of lactide or lactic acid. For example, the cross-linked polylactic acid resin may be prepared by polymerization of lactic acid, which is obtained by fermentation of starch extracted from corn, potatoes, and the like. Since corn, potatoes and the like are renewable plant resources, the polylactic acid resin can effectively solve problems due to depletion of petroleum resources.

In addition, the polylactic acid resin emits a much smaller amount of environmentally toxic substances, such as HCl and the like, during use or disposal than petroleum-based materials, such as polyvinyl chloride (PVC) and the like, and is environmentally friendly in that the polylactic acid resin is easily degradable in a natural environment even when discarded.

The polylactic acid resin can be classified into crystalline polylactic acid (c-polylactic acid) resins and amorphous polylactic acid (a-polylactic acid) resins. Here, a board using a crystalline polylactic acid resin can suffer from bleeding, that is, a phenomenon that a plasticizer flows out of a surface of the board. On the other hand, although a board using an amorphous polylactic acid resin does not suffer from bleeding, the amorphous polylactic acid resin can cause low dimensional stability and thermal stability. Thus, the crystalline and amorphous polylactic acid resins may be mixed for use in the board.

Here, the polylactic acid resin may include at least one selected from among poly-L-lactide, poly-D-lactide and poly-L,D-lactide.

The wood fiber, which is included in the board according to the present invention, may have an apparent specific gravity from 100 kg/m³ to 500 kg/m³, without being limited thereto, and may include less than 3.0% water. If the apparent specific gravity of the wood fiber is less than 100 kg/m³, it is difficult to add the wood fiber, and if the apparent specific gravity is greater than 500 kg/m³, it is difficult to mix the wood fiber. If the amount of water is 3.0% or more in the wood fiber, there is a difficulty due to generation of water vapor during processing and there is a high possibility of hydrolysis of PLA.

The present invention also provides a multilayer flooring material including the board as described above. Since the board includes the cross-linked polylactic acid resin and the wood fiber, the board allows easy thermal processing due to increase in melt strength thereof, and exhibits improved physical properties in terms of water resistance, tensile strength, elongation, and the like.

### Method for Preparing Board

According to one embodiment of the present invention, a method for preparing a board includes: preparing a polylactic acid resin mixture by mixing a polylactic acid resin, a crosslinking agent, and a crosslinking aid; crosslinking the polylactic acid resin mixture through heat-initiated crosslinking; preparing a composition for board formation, which includes the cross-linked polylactic acid resin and 50 parts by weight to 150 parts by weight of wood fiber based on 100 parts by weight of the cross-linked polylactic acid resin; and forming a board by thermoforming the composition for board formation, followed by post-processing.

According to another embodiment of the present invention, a method for preparing a board includes: preparing a polylactic acid resin mixture by mixing a polylactic acid resin and a crosslinking aid; crosslinking the polylactic acid resin mixture through electron beam irradiation crosslinking; preparing a composition for board formation, which includes the cross-linked polylactic acid resin and 50 parts by weight to 150 parts by weight of wood fiber based on 100 parts by weight of the cross-linked polylactic acid resin; and forming a board by thermoforming the composition for board formation, followed by post-processing.

First, to obtain the cross-linked polylactic acid resin, the crosslinking agent or the crosslinking aid may be present in an amount of 0.01 parts by weight to 10.0 parts by weight based on 100 parts by weight of the polylactic acid resin. If the amount of the crosslinking agent or the crosslinking aid is less than 0.01 parts by weight, there is a problem in that crosslinking is not started, and if the amount of the crosslinking agent is greater than 10.0 parts by weight, there is a problem of difficulty in processing due to thermosetting properties caused by extremely high degree of crosslinking.

The crosslinking agent for heat initiation crosslinking may be an organic peroxide. Specifically, the crosslinking agent for heat initiation crosslinking may include t-amylperoxy-2-ethylhexanoate, 1,1-di(t-butylperoxy)-3,3,5-trimethylcyclohexane, dicumyl peroxide (DCP), 2,5-dimethyl-2,5-di(t-butylperoxy)hexane, t-butyl-(2-ethylhexyl)monoperoxycarbonate, and the like, without being limited thereto. In addition, the crosslinking agent may also include crosslinking aids such as triallyl isocyanurate (TAIC), and the like.

The crosslinking aid for electron beam irradiation crosslinking may include triallyl isocyanurate (TAIC), and the like, without being limited thereto.

Next, the wood fiber, which is a main component of the composition for board formation according to the present invention, may be present in an amount of 50 parts by weight to 150 parts by weight in the composition based on 100 parts by weight of the polylactic acid resin. If the amount of the wood fiber is less than 50 parts by weight, there are problems in that processing of the board, such as cutting and the like, becomes difficult, and that commercialization of the board is difficult due to increase in price. In addition, if the amount of the wood fiber is greater than 150 parts by weight, there are problems in that thermoforming of the board is difficult, and that the board is difficult to use due to low flexural strength and the like.

Here, the wood fiber may have an apparent specific gravity from 100 kg/m³ to 500 kg/m³, without being limited thereto, and may include less than 3.0% water. If the apparent specific gravity is less than 100 kg/m³, it is difficult to add the wood fiber, and if the apparent specific gravity is greater than 500 kg/m³, it is difficult to mixing the wood fiber. If the amount of water is 3.0% or more, there is a difficulty due to generation of water vapor during processing, and there is a high possibility of hydrolysis of PLA.

According to the present invention, the composition for board formation may further include a processing aid.

An acrylic copolymer, which is used as the processing aid, reinforces melt strength of the PLA resin, and thus enables calendering and press processing. According to the present invention, commercially available examples of the acrylic copolymer may include PA828 (LG Chemical Co., Ltd.), Biostrength™ 700 (Arkema Co., Ltd.), BPMS-255, 265 (Rohm and Haas Co., Ltd.), Biomax® Strong 100, 120 (DuPont Co., Ltd.), and the like.

The processing aid may be present in an amount of 0.1 parts by weight to 50 parts by weight based on 100 parts by weight of the polylactic acid resin. If the amount of the processing aid is less than 0.1 parts by weight, reinforcement of the melt strength of the PLA resin is insufficient, and if the amount of the processing aid is greater than 50 parts by weight, there are problems of insignificant reinforcement of the melt strength thereof, and increase in production costs thereof.

For crosslinking of the polylactic acid resin, 0.01 parts by weight to 10.0 parts by weight of the crosslinking agent or the crosslinking aid is added to 100 parts by weight of the polylactic acid resin in a Banbury mixer, a kneader or an extruder, followed by heat-initiated crosslinking at 120° C. to 200° C. or crosslinking through 10 kGy to 100 kGy electron beam irradiation.

According to the present invention, the raw materials of the composition for board formation including the cross-linked polylactic acid resin and the wood fiber are mixed and kneaded, thereby preparing the composition for board formation. Here, for example, mixing and kneading of the raw materials may be performed by mixing and kneading liquid or powder raw materials using a super mixer, an extruder, a kneader, a 2-roll or 3-roll machine, or the like. In addition, for more efficient mixing in the process of mixing and kneading of the raw materials, mixing and kneading may be repeatedly performed in multiple stages, for example, by kneading the raw materials at about 120° C. to about 200° C. using a Banbury mixer, followed by primary and secondary mixing of the kneaded raw materials at about 120° C. to about 200° C. using a 2-roll machine or the like. Here, since details of each of the raw materials are as described above, descriptions thereof will be omitted.

Next, the composition for board formation is subjected to thermoforming into a board at 120° C. to 200° C. Here, thermoforming may be performed at 120° C. to 200° C. If the thermoforming temperature is less than 120° C., there is a problem of difficult thermoforming, and if the thermoforming temperature is greater than 200° C., there is a problem of carbonization of the resin.

Thermoforming may be performed by a general method known in the art, without being limited thereto. For example, thermoforming may be performed using a typical apparatus, such as a reverse L-type 4-roll calender, and the like.

The present invention also provides a method for preparing a multilayer flooring material, which includes the method for preparing a board described above. The method for preparing a multilayer flooring material includes: thermoforming the composition, which includes 50 parts by weight to 150 parts by weight of the wood fiber based on 100 parts by weight of the cross-linked polylactic acid resin, into a board; and performing sanding, surface treatment, aging and cutting.

In addition, the method for preparing a multilayer flooring material may include: preparing a transparent layer, a print layer and a back layer of a board using the composition including a cross-linked polylactic acid resin; preparing a base layer using the composition obtained by mixing 50 parts by weight to 150 parts by weight of wood fiber with 100 parts by weight of the cross-linked polylactic acid resin; performing thermal lamination of the print layer and the back layer on upper and lower sides of the base layer, respectively; printing on the print layer; laminating the transparent layer on the printed print layer; coating the transparent layer with a surface treating agent; and performing aging, cutting and packaging.

According to the invention, the method for preparing a board enables extremely easy working of the board due to excellent processability of the board, and the board prepared by the method exhibits excellent water resistance.

### PREPARATION OF BOARDS ACCORDING TO EXAMPLE AND COMPARATIVE EXAMPLE

Hereinafter, the present invention will be explained in more detail with reference to some examples. However, it should be understood that these examples are provided for illustration only and are not to be construed in any way as limiting the present invention.

A description of details apparent to those skilled in the art will be omitted for clarity.

### EXAMPLE

1.0 part by weight of 2,5-dimethyl-2,5-di(t-butylperoxy)hexane corresponding to a heat-initiated crosslinking agent, and 0.5 parts by weight of TAIC corresponding to a crosslinking aid were added to 100 parts by weight of a polylactic acid resin, followed by crosslinking using a twin-screw extruder at 160° C. to 200° C., thereby preparing a cross-linked polylactic acid resin.

1.0 part by weight of TAIC corresponding to a crosslinking aid was added to 100 parts by weight of a polylactic acid resin, followed by sufficiently dispersing the crosslinking aid in the polylactic acid resin using a twin-screw extruder at 160° C. to 200° C. The crosslinking aid-containing polylactic acid resin was subjected to 10 kGy to 100 kGy electron beam irradiation, thereby preparing a cross-linked polylactic acid resin.

A thermoforming composition, which included the cross-linked polylactic acid resin through heat-initiated crosslinking or electron beam irradiation, was subjected to extrusion or calendering at 120° C. to 200° C., thereby preparing a transparent layer, a print layer and a back layer of a multilayer board. In addition, a composition, in which 80 parts by weight of wood fiber was mixed with 100 parts by weight of the cross-linked polylactic acid resin, was subjected to calendering at 120° C. to 200° C., thereby preparing a base layer or a chip-through board of the multilayer board.

### Comparative Example

A board was prepared in the same manner as in Example except that an uncross-linked polylactic acid resin was used instead of the cross-linked polylactic acid resin.

Evaluation

The boards prepared in Example and Comparative Example were evaluated as to lamination processability and properties (tensile strength). Results are shown in Table 1.

TABLE 1

| | Example | Comparative Example |
|---|---|---|
| Water resistance* | 8% | 60% |
| Processability | Excellent calendering | Unable to perform |
| | processability | calendering |

*Evaluation of water resistance: Reduction ratio of tensile strength between before and after storage at 60° C. and a humidity of 90% for 96 hours.

From the evaluation results, it can be seen that, since the board according to the present invention exhibited improved melt strength by including the cross-linked polylactic acid resin, the board could be processed at a relatively high processing temperature, and exhibited excellent water resistance.

Although the present invention has been described with reference to some embodiments, it should be understood that the foregoing embodiments are provided for illustration only, and that various modifications, changes, alterations, and equivalent embodiments can be made by those skilled in the art without departing from the spirit and scope of the invention. Therefore, the scope of the invention should be limited only by the accompanying claims and equivalents thereof.

1. A board comprising:
a cross-linked polylactic acid resin, and
wood fiber,
wherein the wood fiber is present in an amount of 50 parts by weight to 150 parts by weight based on 100 parts by weight of the cross-linked polylactic acid resin, and the cross-linked polylactic acid resin is obtained through heat-initiated crosslinking or irradiation.

2. The board according to claim 1, wherein the polylactic acid resin comprises at least one selected from among poly-L-lactide, poly-D-lactide and poly-L,D-lactide.

3. The board according to claim 1, wherein the wood fiber has an apparent specific gravity from 100 kg/m³ to 500 kg/m³, and comprises 3.0% or less water.

4. A method for preparing a polylactic acid resin, comprising:
preparing a polylactic acid resin mixture by mixing a polylactic acid resin, a crosslinking agent, and a crosslinking aid;
crosslinking the polylactic acid resin mixture through heat-initiated crosslinking;
preparing a composition for board formation, the composition comprising the cross-linked polylactic acid resin and 50 parts by weight to 150 parts by weight of wood fiber based on 100 parts by weight of the cross-linked polylactic acid resin; and
forming a board by thermoforming of the composition, followed by post-processing.

5. A method for preparing a polylactic acid resin, comprising:
preparing a polylactic acid resin mixture by mixing a polylactic acid resin and a crosslinking aid;
crosslinking the polylactic acid resin mixture through electron beam irradiation crosslinking;
preparing a composition for board formation, which comprises the cross-linked polylactic acid resin, and 50 parts by weight to 150 parts by weight of wood fiber based on 100 parts by weight of the cross-linked polylactic acid resin; and
forming a board by thermoforming of the composition, followed by post-processing.

6. The method according to claim 4, wherein the polylactic acid resin comprises at least one selected from among poly-L-lactide, poly-D-lactide and poly-L,D-lactide.

7. The method according to claim 4, wherein the wood fiber has an apparent specific gravity from 100 kg/m³ to 500 kg/m³, and comprises 3.0% or less water.

8. The method according to claim 4, wherein the crosslinking agent is present in an amount of 0.01 parts by weight to 10.0 parts by weight based on 100 parts by weight of the polylactic acid resin, and comprises at least one selected from among t-amylperoxy-2-ethylhexanoate, 1,1-di(t-butylperoxy)-3,3,5-trimethylcyclohexane, dicumyl peroxide (DCP), 2,5-dimethyl-2,5-di(t-butylperoxy)hexane, and t-butyl-(2-ethylhexyl)monoperoxycarbonate.

9. The method according to claim 4, wherein the crosslinking aid is present in an amount of 0.01 parts by weight to 10.0 parts by weight based on 100 parts by weight of the polylactic acid resin, and is triallyl isocyanurate.

10. The method according to claim 4, wherein the polylactic acid resin mixture further comprises a processing aid.

11. The method according to claim 10, wherein the processing aid is an acrylic copolymer.

12. The method according to claim 4, wherein heat-initiated crosslinking is performed at a temperature from 120° C. to 200° C.

13. A method according to claim 5, wherein electron beam irradiation is performed at an irradiation dose from 10 kGy to 100 kGy.

14. A multilayer flooring material comprising the board according to claim 1.

15. A method for preparing a multilayer flooring material, comprising: the method for preparing a board according to claim 4.

16. The method according to claim 5, wherein the polylactic acid resin comprises at least one selected from among poly-L-lactide, poly-D-lactide and poly-L,D-lactide.

17. The method according to claim 5, wherein the wood fiber has an apparent specific gravity from 100 kg/m³ to 500 kg/m³, and comprises 3.0% or less water.

18. The method according to claim 5, wherein the crosslinking aid is present in an amount of 0.01 parts by weight to 10.0 parts by weight based on 100 parts by weight of the polylactic acid resin, and is triallyl isocyanurate.

19. The method according to claim 5, wherein the polylactic acid resin mixture further comprises a processing aid.

20. A method for preparing a multilayer flooring material, comprising: the method for preparing a board according to claim 5.
